(19) United States
(12) Patent Application Publication
(10) Pub. No.: US 2026/0111059 A1
(43) Pub. Date: Apr. 23, 2026

(54) DUST-RESISTANT FOLDABLE DISPLAY DEVICE

(71) Applicant: Google LLC, Mountain View, CA (US)

(72) Inventors: Tsung-Yuan Ou, Taipei City (TW); Wen-Shian Lin, Taipei City (TW); Yen-Ting Liu, Taipei City (TW)

(21) Appl. No.: 18/924,768

(22) Filed: Oct. 23, 2024

(51) Int. Cl. G06F 1/16; F16C 11/04

(52) U.S. Cl. CPC G06F 1/1641; F16C 11/04; G06F 1/1681

(57) ABSTRACT

An example foldable computing device includes a first housing assembly and a second housing assembly. The foldable computing device includes a hinge assembly including a hinge cover and hinge mechanism coupled to the first and second housing assemblies. The foldable computing device includes a foldable display disposed over at least a portion of the first housing assembly, at least a portion of the hinge assembly, and at least a portion of the second housing assembly. The foldable computing device includes a cloth joined to the first housing assembly and the second housing assembly across the hinge cover, in which the cloth is disposed between the hinge mechanism and the first housing assembly, the hinge cover, and the second housing assembly. The cloth folds as the first housing assembly moves relative to the second housing assembly and reduces intrusion of particulates to the electrical components of the foldable computing device.

### BACKGROUND

Foldable designs of mobile computing devices (such as smartphones, smartwatches, portable gaming devices, laptops, etc.) use flexible displays that are configured to fold, such that the mobile computing devices can be designed with a significantly larger screen (as compared to standard non-foldable computing devices). These foldable mobile computing devices may include a first housing assembly mechanically coupled to a second housing assembly and a folding mechanism that allows the first housing assembly to close relative to the second housing assembly.

### SUMMARY

In general, techniques of this disclosure are directed to a foldable device including a cloth joined to a foldable display hinge assembly to mitigate dust ingression. A foldable computing device (e.g., a foldable smartphone, a foldable tablet, etc.) may include at least two assemblies (e.g., panels) and a mechanism configured to allow the assemblies to be moved into a collapsed or folded state in which the device is considered closed, and an expanded state in which the device is considered open. For example, a foldable computing device may comprise a first housing assembly that includes a first subset of a plurality of electrical components and a second housing assembly that includes a second subset of the plurality of electrical components. A hinge assembly including a hinge cover and hinge mechanism may be coupled to the first housing assembly, such that the hinge assembly facilitates opening and closing of the first housing assembly relative to the second housing assembly. However, at edges of these foldable mobile computing devices, gaps may be present (e.g., between electrical components of the housing assemblies and the mechanical components that provide the folding mechanism). Dust, sand, and other particles can enter into these gaps and make contact with the components of the device, which can negatively affect or damage the device's normal functionality.

In accordance with one or more aspects of this disclosure, the foldable computing device may further include a cloth (e.g., a cloth comprising a fiber derived from a liquid crystal polymer) that is joined to the first housing assembly and the second housing assembly across the hinge cover (e.g., by a tape), in which the cloth may be disposed between the hinge assembly and the first housing assembly, the hinge cover, and the second housing assembly. As such, the cloth may create one or more seals over one or more gaps between the hinge assembly and the interiors of the first and second housing assemblies, which may be present at one or more edges of the foldable computing device. In this way, the cloth may improve resistance of foldable computing devices to dust, water, sand, and other particulates.

In one example, a foldable computing device comprises a first housing assembly that includes a first subset of a plurality of electrical components, and a second housing assembly that includes a second subset of the plurality of electrical components. The foldable computing device further comprises a hinge cover coupled to the first housing assembly and the second housing assembly. The foldable computing device further comprises a cloth joined to the first housing assembly and the second housing assembly across the hinge cover. The foldable computing device further comprises a hinge mechanism joined to the first housing assembly, the hinge cover, and the second housing assembly, wherein the cloth is disposed between the hinge mechanism and the first housing assembly, the hinge cover, and the second housing assembly.

The details of one or more examples are set forth in the accompanying drawings and the description below. Other features, objects, and advantages of the disclosure will be apparent from the description and drawings, and from the claims.

### BRIEF DESCRIPTION OF DRAWINGS

FIG. 1 is a schematic diagram illustrating a foldable device including a first housing assembly mechanically joined to a second housing assembly by a hinge assembly, in accordance with one or more aspects of this disclosure.

FIG. 2 is a diagram illustrating an example cloth joined across a hinge cover including at least two straight edges, in accordance with one or more aspects of this disclosure.

FIG. 3 is a diagram illustrating another view of the foldable device of FIG. 1 including a first housing assembly mechanically joined to a second housing assembly by a hinge assembly, in accordance with one or more aspects of this disclosure.

FIG. 4 is a diagram illustrating another view of the foldable device of FIG. 1 including a first housing assembly mechanically joined to a second housing assembly by a hinge assembly, in accordance with one or more aspects of this disclosure.

FIG. 5 is a diagram illustrating another view of the foldable device of FIG. 1 including a first housing assembly mechanically joined to a second housing assembly by a hinge assembly, in accordance with one or more aspects of this disclosure.

### DETAILED DESCRIPTION

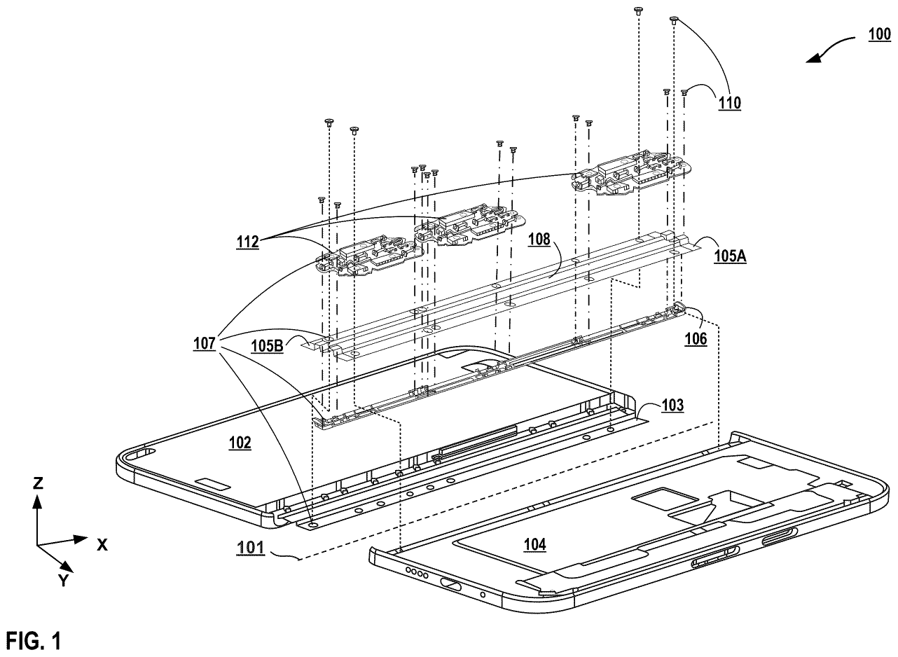

FIG. 1 is a schematic diagram illustrating a foldable device including a first housing assembly mechanically joined to a second housing assembly by a hinge assembly, in accordance with one or more aspects of this disclosure. As shown in the example of FIG. 1, a foldable computing device 100, which may be a foldable mobile computing device, includes a first housing assembly 102 and a second housing assembly 104. Foldable computing device 100 may also include hinge cover 106 and hinge mechanism 112, which may be represented by one or more hybrid modules and/or one or more torque modules. In some examples, hinge assembly 112 may be considered to include or be at least one hinge actuator. In general, hinge cover 106 and hinge mechanism 112 may form a hinge assembly, in which the hinge assembly facilitates opening and closing of first housing assembly 102 relative to second housing assembly 104. That is, second housing assembly 104 may be mechanically coupled to first housing assembly 102 via the hinge assembly, in which the hinge assembly is disposed between first housing assembly 102 and second housing assembly 104.

Foldable computing device 100 may represent any foldable device, including a smartphone, smartwatch, a portable gaming system, a laptop computer, an electronic reading device (so-called “e-reader”), or any other mobile computing device capable of having an expanded display (including a rollable display in which the screen unrolls to expand the display), e.g., a foldable display. Moreover, while described with respect to a mobile computing device, various aspects of this disclosure may apply to computer monitors, smart televisions, all-in-one computers, or any other computing device having an expandable display, but which may receive power from a fixed or constant power source and lacks a battery or other portable power source to enable mobile operation.

First housing assembly 102 may represent a housing assembly configured to house or otherwise secure a subset of electrical components that form foldable computing device 100. First housing assembly 102 may be formed from any suitable material, such as carbon fiber, plastic or other polymers, aluminum or other metals, glass, or combinations thereof.

Generally, a housing assembly, such as first housing assembly 102, may refer to an exterior shell of the foldable mobile computing device, including any inner molding or other supports to house the subset of electrical components and physical inputs (e.g., buttons, sliders, ports, etc.) and/or provide outlets for outputs (e.g., speaker holes, microphone holes, camera openings, etc.). Second housing assembly 104 may be similar, if not substantially similar, to first housing assembly 102 in terms of material, and general form factor, but may differ in supports, cutouts, and molding to secure a different subset of the electrical components and inputs (e.g., buttons, sliders, ports—such as headphone ports, charging ports, and the like—etc.) and provide different outlets for outputs. In some examples, first housing assembly 102 and/or second housing assembly 104 may include one or more brackets 103. As shown in the example of FIG. 1, brackets 103 may include one or more holes from plurality of holes 107, which may be a plurality of fastener holes for one or more fasteners 110.

Hinge mechanism 112 and hinger cover 106 may form a hinge assembly which may provide a hinge or folding mechanism, or facilitate opening and closing of foldable computing device 100 in which first housing assembly 102 is operable to rotate around the hinge assembly in order to cover, when closed, at least a portion of the interior (which may be the top face of housing assemblies 102 and 104 shown in the example of FIG. 1, in which the exterior of housing assemblies 102 and 104 is not shown for ease of illustration) of second housing assembly 104 (and potentially cover the entirety of the interior of second housing assembly 104). Hinge assembly 106 may also facilitate opening of foldable computing device 100 in which first housing assembly is operable to rotate around hinge assembly 106 to uncover at least the portion of second housing assembly 104. Although described with respect to first housing assembly 102 rotating around the hinge assembly, one of or both first housing assembly 102 and second housing assembly 104 may rotate around the hinge assembly. For example, first housing assembly 102 and second housing assembly 104 may be configured to rotate about axis 101, which defines a middle axis of the hinge assembly in the x-direction.

In general, hinge mechanism 112 may provide smooth and controlled folding or unfolding of foldable computing device 100. In some examples, hinge mechanism 112 may be a mechanical hinge. In some examples, hinge mechanism 112 may be or include one or more hybrid modules, which may include both mechanical and electronic components to ensure stability, precision, and durability in the hinge. For example, a hybrid module may include mechanical parts, such as springs or gears, combined with electronic sensors to monitor the position or angle of the fold. In some examples, hinge mechanism 112 may be or include one or more torque modules, which may control the resistance (i.e., torque) when the hinge assembly moves, e.g., when foldable computing device 100 is folded. That is, hinge mechanism 112 may regulate how much force is needed to move the hinge assembly. In this way, hinge mechanism 112 may keep foldable computing device 100 in a particular position when folded or unfolded, such that foldable computing device 100 may not fall open or snap close, and rather may fold smoothly. Hinge mechanism 112 may ensure the hinge assembly operates seamlessly, while maintaining durability over repeated use of foldable computing device 100.

Each of first housing assembly 102 and second housing assembly 104 may include an inner surface or interior and an outer surface or exterior. When first housing assembly 102 is operable to rotate around the hinge assembly in order to cover, when closed, at least a portion of the interior of second housing assembly 104, the outer surface of first housing assembly 102 may be visible when looking down at foldable computing device 100 in the z-axis, and the outer surface of second housing assembly 104 may be visible when looking up at device foldable computing 100 in the z-axis. The inner surfaces of first housing assembly 102 and second housing assembly 104 may not be externally visible when device 100 is closed.

In general, foldable computing device 100 may include a foldable (or flexible) display (not shown in FIG. 1) that spans the hinge assembly and at least a portion of first housing assembly 102 and at least a portion of second housing assembly 104. The foldable display may be one continuous display that can flex or bend without breaking when first housing assembly 102 moves relative to second housing assembly 104. The foldable display may be disposed, in some instances, over the entirety (or nearly the entirety considering bezels and other holes for placement of ports or other openings to accommodate the electrical components, such as a camera, a speaker, a microphone, a fingerprint reader, etc.) of the interior portion of both first housing assembly 102 and second housing assembly 104. Examples of foldable displays include, but are not limited to, liquid crystal displays (LCD), light emitting diode (LED) displays, organic light-emitting diode (OLED) displays, micro light-emitting diode (microLED) displays, an active matrix OLED (AMOLED, any other display capable of bending or otherwise flexing along an axis (e.g., a middle line of the display either length-or width-wise, such as axis 101), or any similar monochrome or color displays capable of outputting visible information to a user of foldable computing device 100.

In addition, although not shown in the example of FIG. 1, foldable computing device 100 may include a portable power source (e.g., a battery, such as a rechargeable lithium ion battery) that powers foldable computing device 100 when disconnected from a constant, or continuous power source (such as a direct power supply provided by an electrical outlet).

The portable power source may provide a constrained or limited power supply to the electronic components of foldable computing device 100. Such electronic components may include the foldable display, one or more sensors (e.g., a camera—including an infrared camera, an accelerometer, a gyroscope, a temperature sensor, a hygrometer, etc.), a fingerprint reader, a processor—including a graphical processing unit, a central processing unit, an application specific integrated circuit (ASIC), a field programmable gate array (FPGA), a digital analogue converter (DAC), a video compression processor, or any other processing circuitry, a memory or other storage device (including both volatile and non-volatile memory), or any other electrical component commonly included within smartphones or other computing devices.

The subset of electrical components housed in first housing assembly 102 to the subset of electrical components housed in second housing assembly 104 may be electrically coupled by, for example, an electrical inter-assembly connecting circuit (e.g., a printed circuit board—PCB). In some examples, the PCB may include physical couplers that facilitate the electrical coupling, where such physical couplers may introduce a vector at which particulates (e.g., dust, sand, etc.) and water may enter one or more of first housing assembly 102 and second housing assembly 104 that may impact operation of the electrical components supporting operation of foldable computing device 100.

In some examples, first housing assembly 102 and second housing assembly 104 may include one or more rigid segments (not shown in FIG. 1) positioned on an inner surface of first housing assembly 102 second housing assembly 104 to provide structure for foldable computing device 100. First housing assembly 102 and second housing assembly 104 may also include one or more flexible segments (not shown in FIG. 1) to facilitate closure or folding of foldable computing device 100. In accordance with one or more aspects of this disclosure, foldable computing device 100 may include one or more supporting plates (e.g., “backer plates” or “backplates”) (not shown in FIG. 1) configured to render segments of a foldable display flexible or rigid. The one or more backplates may be positioned between emissive elements of the foldable display (e.g., OLEDs) and the inner surfaces of first housing assembly 102 and second housing assembly 104.

In general, foldable computing device 100 may include cloth 108, which may be joined to first housing assembly 102 and second housing assembly 104 across hinge cover 106. Specifically, as shown in the example of FIG. 1, cloth 108 may be disposed between hinge mechanism 112 and first housing assembly 102, hinge cover 106, and second housing assembly 104. As further shown in the example of FIG. 1, cloth 108 may be attached to hinge mechanism 112 by one or more tapes, e.g., double-sided tape (DST) 105A and 105B. That is, cloth 108 may include a first DST 105A attached to a first portion of a top face of cloth 108 (as shown in the example of FIG. 1, in which the bottom face of cloth 108 is not shown for ease of illustration), and a second DST 105B attached to a second portion of the top face of cloth 108. As shown in the example of FIG. 1, first DST 105A may be attached to a first end of cloth 108, and second DST 105B may be attached to a second end of cloth 108. In some examples, cloth 108 may be attached using a single DST, which may or may not span the entirety of cloth 108, or may include additional DST pieces. Furthermore, in some examples, cloth 108 may be attached to brackets 103 and/or hinge cover 106 by DST, e.g., cloth 108 may include a third DST attached to a first portion of a bottom face of cloth 108 (not shown for ease of illustration), and a fourth DST attached to a second portion of the bottom face of cloth 108 (not shown for ease of illustration). For example, the third DST may be attached to the first end of cloth 108, and the fourth DST may be attached to the second end of cloth 108. In the example of FIG. 1, hinge mechanism 112, cloth 108, hinge cover 106, and/or brackets 103 may be fastened together by one or more fasteners 110. For example, fasteners 110 may include one or more screws configured to screw into one or more holes from plurality of holes 107. Specifically, first housing assembly 102 may comprise a first bracket from brackets 103, second housing assembly 104 may comprise a second bracket from brackets 103, in which the first bracket and the second bracket further comprise a first plurality of fastener holes. Hinge cover 106 may comprise a second plurality of fastener holes, cloth 108 may comprise a third plurality of fastener holes, and hinge mechanism 112 may comprise a fourth plurality of fastener holes. The first, second, third, and fourth pluralities of fastener holes may be referred to herein collectively as “holes 107.” In some examples, holes 107 may include various shapes or geometries. In some examples, holes 107 may be formed from one or more of laser etching or chemical etching. In some examples, holes 107 may extend a length of the components of FIG. 1 (e.g., along axis 101 of FIG. 1). As shown in the example of FIG. 1, brackets 103 may be joined to hinge cover 106, cloth 108, and hinge mechanism 112 by one or more fasteners 110, which may be one or more screws.

In general, foldable computing devices may have multiple dust ingression paths, e.g., gaps, which may be harmful to the foldable computing devices as dust can cause delamination (e.g., separation or peeling apart of layers such as the OLED panel, protective layers, adhesives, etc.), growing dark spots (GDS), H-Line formation (e.g., visible horizontal or vertical lines that can appear on foldable displays, due to mechanical stress or defects), ultra-thin glass (UTG) crack, and/or other damage, and thus damage the functionality of the foldable display. For example, an example dust ingression path may exist between hinge cover 106 and the interior surfaces of first housing assembly 102 and second housing assembly 104. That is, in general, the hinge assembly may be arranged such that there is at least a first gap between first housing assembly 102 and the hinge assembly (e.g., one or more of hinge cover 106 and hinge mechanism 112) and at least a second gap between second housing assembly 104 and the hinge assembly. In some examples, there may be fewer or additional gaps present between the housing assemblies and the hinge assembly. In general, cloth 108 may span the first gap between first housing assembly 102 and the hinge assembly and the second gap between second housing assembly 104 and the hinge assembly, and in some examples, one or more additional gaps between the housing assemblies and the hinge assembly. “Span”, as used throughout this disclosure, may be defined as covering or extending over a specific distance, or covering or extending over a portion or entirety of a specific element/component. Thus, cloth 108 may cover or extend over a portion or the entirety of the hinge assembly and/or any gaps between the hinge assembly and the housing assemblies. As such, aspects of this disclosure may provide means for sealing any gaps between the hinge assembly and first housing assembly 102 and between the hinge assembly and second housing assembly 104, such that the electrical components of first housing assembly 102 and second housing assembly 104 are protected from dust or particulate ingression. Although only one edge of foldable computing device 100 may be illustrated and described throughout this disclosure, the aspects of this disclosure may be applied to other edges along foldable computing device 100.

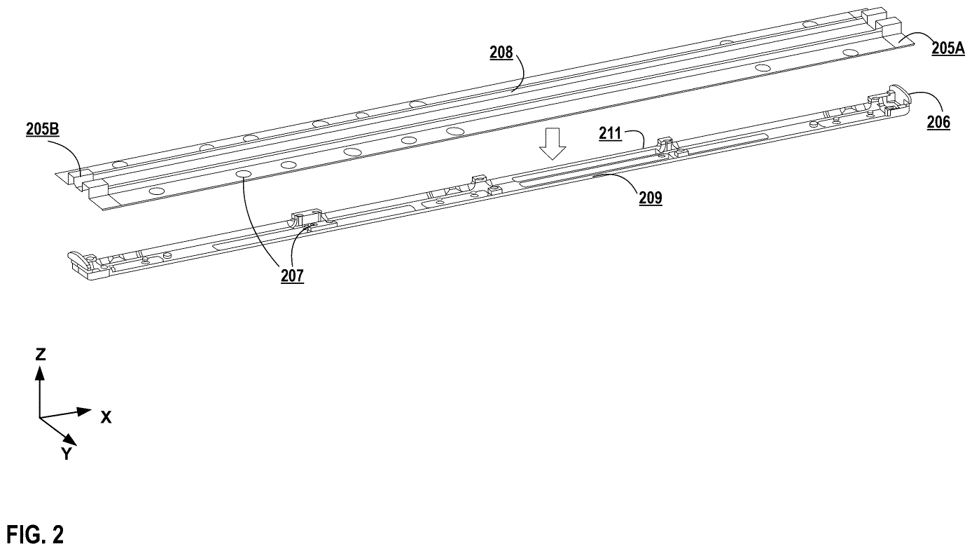

FIG. 2 is a diagram illustrating an example cloth joined across a hinge cover including at least two straight edges, in accordance with one or more aspects of this disclosure. Cloth 208, hinge cover 206, DST 205A, DST 205B, and plurality of holes 207 may each represent another view of cloth 108, hinge cover 106, DST 105A, DST 105B, and plurality of holes 107 of FIG. 1, respectively. As shown in the example of FIG. 2, in some examples, hinge cover 206 includes first straight edge 209 and second straight edge 211.

In general, to improve the fabric sheet implementation involving cloth 208, hinge cover 206 may include at least two straight edges 209 and 211. In general, cloth 208 may span across hinge cover 206. In some examples, cloth 208 may span straight edges 209 and 211. For example, cloth 208 may span at least a majority (e.g., 60%, 65%, 70%, 75%, 80%, 85%, 90%, 95%, or 100%) of straight edges 209 and 211. In general, cloth 208 may fold, flex, bend, stretch, or otherwise move as the first housing assembly moves relative to the second housing assembly (e.g., as the foldable computing device is opened and closed). Typically, curved, irregular, or rugged edges may create areas of uneven tension, which may lead to premature wear or distortion of fabric. As such, straight edges 209 and 211 may help ensure even tension distribution on cloth 208 when moving in conjunction with hinge cover 206, e.g., the tension on cloth 208 may be distributed more evenly when the foldable computing device is folded or unfolded. In some examples, straight edges 209 and 211 may help improve the durability of cloth 208 by preventing cloth 208 from potentially getting caught, pinched, or snagged when moving in conjunction with hinge cover 206. That is, straight edges 209 and 211 may help prevent fraying or tearing of cloth 208, especially in critical folding areas. Furthermore, straight edges 209 and 211 may provide a consistent fold line for cloth 208, e.g., may help ensure cloth 208 folds neatly when the foldable computing device is closed, which may reduce the potential for unwanted creasing. Lastly, straight edges 209 and 211 may provide overall easier assembly and integration of cloth 208, as cloth 208 may be more easily and precisely aligned with hinge cover 206. As such, in general, straight edges 209 and 211 may help to provide a more consistent and secure fabric sheet implementation, which may further help prevent the likelihood of dust ingression paths being present.

In some examples, cloth 208 may be a fabric sheet. In some examples, cloth 208 may be or include a woven fabric or a nonwoven fabric. In some examples, cloth 208 may be or include a knitted fabric. In some examples, cloth 208 may comprise a woven fabric including one or more of a thermoplastic polymer, a liquid crystal polymer, an amorphous polymer, and an elastomer. In some examples, the material of cloth 208 may be chosen based on mechanical properties including, but not limited to, tensile strength (i.e., the maximum stress a material can withstand while being stretched or pulled before breaking), flexibility or bendability, fatigue resistance, elongation (i.e., stretchability), abrasion resistance, shear strength, tear resistance, compressive strength, creep resistance, puncture resistance, impact resistance, heat resistance, thickness, and weight. In some examples, cloth 208 may be a material with a tensile strength within a range from about 1,500 MPa to about 4,000 MPa. In some examples, cloth 208 may be a material with an elongation within a range from about 1% to about 5%. In some examples, cloth 208 may be a material with a tear resistance within a range from about 1,000 N/m to about 2,000 N/m. In some examples, cloth 208 may be a material with a compressive strength within a range from about 200 MPa to about 300 MPa. In some examples, cloth 208 may be a material with a shear strength within a range from about 300 MPa to about 900 MPa. In some examples, cloth 208 may be a material with a puncture resistance within a range from about 500 N to about 1,200 N. In some examples, cloth 208 may be a material with an impact resistance within a range from about 500 J/m² to about 1,500 J/m². In some examples, cloth 208 may be a material with a low or very low creep resistance, e.g., about 0.1% creep at 10 years under 50% load, <1% over long periods, etc. In some examples, cloth 208 may be a material with high thermal stability, i.e., cloth 208 may maintain its strength and shape in high-temperature environments (e.g., temperatures up to 330° C. (626° F.)) without melting. In some examples, cloth 208 may be a material with a thickness within a range from about 10 micrometers to about 1.0 mm. In some examples, cloth 208 may be a material with a weight within a range from about 0.5 g/cm³ to about 1.5 g/cm³. In some examples, the material of cloth 208 may be additionally or alternatively be chosen based on properties such as color and texture, e.g., cloth 208 may comprise smooth and low-friction textures, textured grip (i.e., microtextured), abrasion-resistant textures, flexible and elastic textures, heat dissipative textures, water-resistant textures, layered textures, etc. In some examples, the material of cloth 208 may be additionally or alternatively be chosen based on factors that contribute to dust-proof capability, e.g., cloth 208 may comprise tight weaves or dense structures, a smooth surface finish (e.g., a non-porous surface), a water-resistant or hydrophobic coating, electrostatic discharge (ESD) coatings or properties, non-porous or laminated layers, elastic or stretch fabrics, an anti-microbial coating, an oleophobic nano-coating or dust-repellent textile treatment, etc. Furthermore, the specific material of cloth 208 may be compatible with the electrical and mechanical components of the foldable computing device such that damage (e.g., melting or another thermal event) does not occur during use of the foldable computing device.

In some examples, cloth 208 may comprise a fiber derived from a liquid crystal polymer, such as Vectran™. Other example materials may include, but are not limited to, Kevlar®, ultra-high-molecular-weight polyethylene, poly(p-phenylene-2,6-benzobisoxazole) fiber, other aramid fibers, other para-aramid fibers, carbon fibers, and basalt fibers. In some examples, cloth 208 may comprise a thickness within a range from about 20 micrometers to about 200 micrometers. In some examples, cloth 208 may comprise a thickness within a range from about 20 micrometers to about 100 micrometers. In some examples, cloth 208 may comprise a thickness of about 40 micrometers.

As shown in the example of FIG. 2, cloth 208 may be applied on top of hinge cover 206 in a-z direction, such that cloth 208 substantially covers a majority (e.g. >80%) of the top face of hinge cover 206 shown in FIG. 2. As shown in FIG. 2, cloth 208 may include first DST 205A attached to a first portion of a top face of cloth 208, and a second DST 205B attached to a second portion of the top face of cloth 208. In some examples, cloth 208 may be attached to hinge cover 206 by DST, e.g., cloth 208 may include a third DST attached to a first portion of a bottom face of cloth 208 (not shown for ease of illustration), and a fourth DST attached to a second portion of the bottom face of cloth 208 (not shown for ease of illustration). For example, the third DST may be attached to the first end of cloth 208, and the fourth DST may be attached to the second end of cloth 208, in which the third and fourth DSTs may adhere to respective end portions of hinge cover 206. As further shown in the example of FIG. 2, both cloth 208 and hinge cover 206 may each include holes from plurality of holes 207, which may be considered a plurality of fastener holes fitted for one or more fasteners. As such, cloth 208 may be joined to hinge cover 206 by one or more fasteners, e.g., one or more screws.

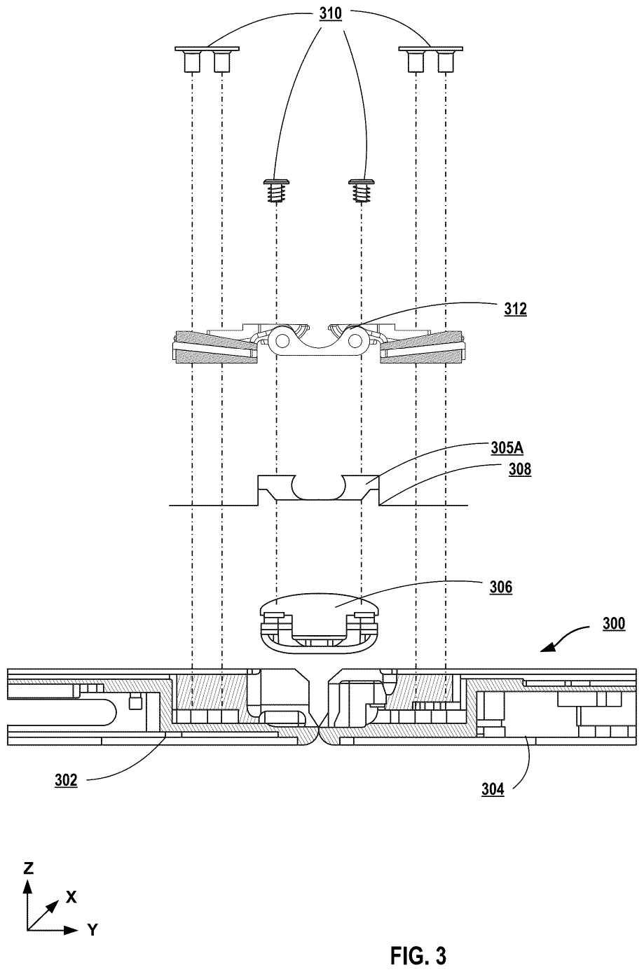

FIG. 3 is a diagram illustrating another view of the foldable device of FIG. 1 including a first housing assembly mechanically joined to a second housing assembly by a hinge assembly, in accordance with one or more aspects of this disclosure. Foldable computing device 300, first housing assembly 302, second housing assembly 304, plurality of fasteners 310, cloth 308, hinge cover 306, DST 305A, and hinge mechanism 312 may each represent another view of foldable computing device 100, first housing assembly 102, second housing assembly 104, plurality of fasteners 110, cloth 108, hinge cover 106, DST 105A, and hinge mechanism 112 of FIG. 1, respectively. FIG. 3 may represent an example assembly of foldable computing device 300.

As shown in the example of FIG. 3, hinge cover 306 may be disposed between first housing assembly 302 and second housing assembly 304, and may be coupled to first housing assembly 302 and second housing assembly 304. Cloth 308 may be joined to first housing assembly 302 and second housing assembly 304 across hinge cover 306. In some examples, DST may be used to adhere a bottom face of cloth 308 to a top face or interior portion of first housing assembly 302, second housing assembly 304, and/or hinge cover 306. As shown in the example of FIG. 3, cloth 308 may include DST 305A which may adhere to a top face of cloth 308, and may adhere to a bottom face of hinge mechanism 312. Hinge mechanism 312 may be joined to first housing assembly 302, hinge cover 306, and second housing assembly 304, in which cloth 308 may be disposed between hinge mechanism 312 and first housing assembly 302, hinge cover 306, and second housing assembly 304. Hinge cover 306 and hinge mechanism 312 may form a hinge assembly, in which the hinge assembly is disposed between first housing assembly 302 and second housing assembly 304.

Cloth 308 may be disposed between at least a portion of an interior of first housing assembly 302 and at least a portion of the hinge assembly, and may be disposed between at least a portion of an interior of second housing assembly 304 and at least a portion of the hinge assembly.

As such, cloth 308 may be integrated with the hinge assembly. That is, as the hinge assembly facilitates opening and closing of first housing assembly 302 relative to second housing assembly 304, cloth 308 may flex, bend, or stretch in accordance with the movement of the hinge assembly. For example, cloth 308 may flex (e.g., stretch) when first housing assembly 302 is closed relative to second housing assembly 304. In some examples, cloth 308 may remain flat (with little to no bend or no excess length) when first housing assembly 302 is open relative to second housing assembly 304. In general, cloth 308 may not inhibit the folding mechanism provided by the hinge assembly.

In general, cloth 308 may create a barrier between the housing assemblies and the hinge cover, such that cloth 308 may protect the electrical components of first housing assembly 302 and second housing assembly 304 from particulate, dust, and/or water ingression. Cloth 308 may span the hinge assembly (e.g., a top face or interior of hinge cover 306 and a bottom face of hinge mechanism 312), and at least a portion of first housing assembly 302 and at least a portion of second housing assembly 304. In some examples, cloth 308 may span at least a majority (e.g., 55%, 60%, 65%, 70%, 75%, 80%, 85%, 90%, 95%, or 100%) of a length of the hinge assembly (e.g., a length corresponding to axis 101 of FIG. 1, which defines a middle axis of the hinge assembly in the x-direction). That is, cloth 308 may span at least a majority (e.g., 55%, 60%, 65%, 70%, 75%, 80%, 85%, 90%, 95%, or 100%) of a length of a top face or interior of hinge cover 306 and a length of a bottom face of hinge mechanism 312. In some examples, more than one cloth may be included in foldable computing device 300. In these examples, cloth 308 may be a first cloth that spans a first edge of the hinge assembly, e.g., 1%, 3%, 5%, 10%, 15%, or 20% of a length of the hinge assembly, and a second cloth (not shown) may span a second edge of the hinge assembly, e.g., 1%, 3%, 5%, 10%, 15%, or 20% of the length of the hinge assembly.

In some examples, cloth 308 may span at least a majority 55%, 60%, 65%, 70%, 75%, 80%, 85%, 90%, 95%, or 100%) of a width (e.g., a width in the y-direction) of the hinge assembly. That is, cloth 308 may span at least a majority (e.g., 55%, 60%, 65%, 70%, 75%, 80%, 85%, 90%, 95%, or 100%) of a width of a top face or interior of hinge cover 306 and a width of a bottom face of hinge mechanism 312. In some examples, cloth 308 may span a full length (i.e., 100%) of the hinge assembly, and/or cloth 308 may span a full width (i.e., 100%) of the hinge assembly.

In general, first housing assembly 302 may comprise a first bracket, and second housing assembly 304 may comprise a second bracket, in which the first bracket and the second bracket further comprise a first plurality of fastener holes. Hinge cover 306 may comprise a second plurality of fastener holes, cloth 308 may comprise a third plurality of fastener holes, and hinge mechanism 312 may comprise a fourth plurality of fastener holes (e.g., the pluralities of holes represented by holes 107 of FIG. 1). As shown in the example of FIG. 3, first housing assembly 302 and second housing assembly 304 may be joined to hinge cover 306, cloth 308, and hinge mechanism 312 by one or more fasteners 310, which may be one or more fasteners fitted for one or more holes from the first, second, third, and fourth pluralities of holes (not shown in FIG. 3 for ease of illustration). For example, fasteners 310 may include one or more screws, one or more nuts/bolts, one or more rivets, one or more pins, and the like. As shown in the example of FIG. 3, fasteners 310 may include a first set of fasteners configured to join hinge mechanism 312, cloth 308, and hinge cover 306 together to form the hinge assembly. Fasteners 310 may include a second set of fasteners configured to join first housing assembly 302 and second housing assembly 304 (e.g., one or more brackets of the first and second housing assemblies) to cloth 308 and hinge mechanism 312. Fasteners 310 may join the components of FIG. 3 by being applied in the-z direction. As such, in general, foldable computing device 300 may be assembled with a “sandwich” design, in which cloth 308 may be securely disposed between hinge cover 306 and hinge mechanism 312, and may be securely disposed between interior portions of the housing assemblies and hinge mechanism 312, e.g., via fasteners 310 and/or DST 305A. As such, cloth 308 may span, and thus effectively seal, any gaps present between the components of FIG. 3, which may prevent dust ingression and thus improve the longevity of foldable computing device 300.

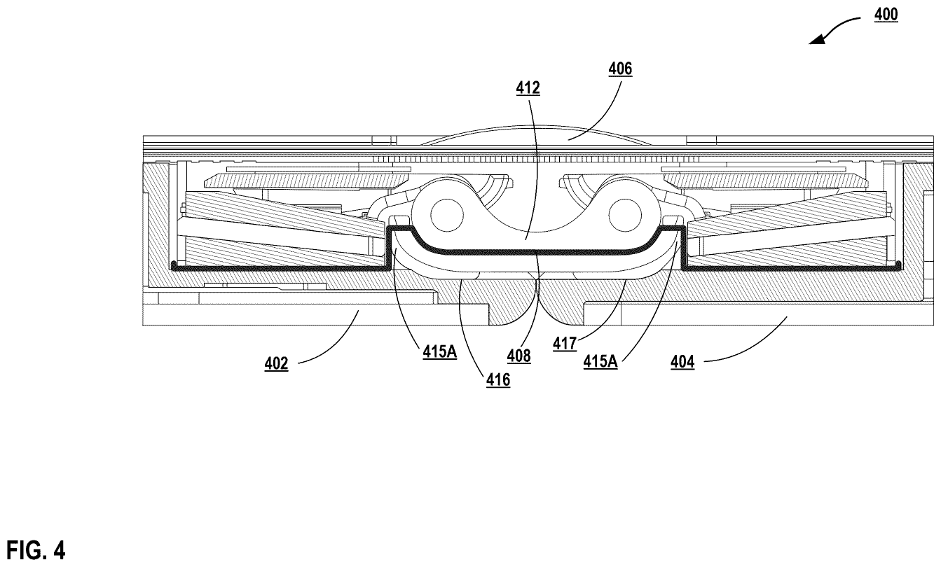

FIG. 4 is a diagram illustrating another view of the foldable device of FIG. 1 including a first housing assembly mechanically joined to a second housing assembly by a hinge assembly, in accordance with one or more aspects of this disclosure. Foldable computing device 400, first housing assembly 402, second housing assembly 404, cloth 408, hinge cover 406, and hinge mechanism 412 may each represent another view of foldable computing device 100, first housing assembly 102, second housing assembly 104, cloth 108, hinge cover 106, and hinge mechanism 112 of FIG. 1, respectively. As shown in the example of FIG. 4, the hinge assembly may be arranged such that a first gap 415A may be present between interior surface 416 of first housing assembly 402 and the hinge assembly (i.e., one or more of hinge cover 406 and hinge mechanism 412), and a second gap 415B may be present between interior surface 417 of second housing assembly 404 and the hinge assembly.

Gap 415A, gap 415B, and other gaps not shown in the example of FIG. 4 (which may be collectively referred to herein as “gaps 415”) may be present along edges of foldable computing device 400 between the hinge assembly (i.e., one or more of hinge cover 406 and hinge mechanism 412), first housing assembly 402, second housing assembly 404, and/or between other mechanical structures and electrical components of foldable computing device 400. Thus, if gaps 415 are left unsealed, particulates (e.g., dust, sand, etc.) may contact or ingress the electrical components included in first housing assembly 402 and second housing assembly 404, which may lead to various damages such as delamination, growing dark spots (GDS), horizontal (H)-line, and ultra-thin glass (UTG) crack, which can negatively affect the functionality and longevity of foldable computing device 400.

In some examples, the dimensions, thickness, material, etc. of cloth 408 may be chosen so as to span one or more gaps 415 between first housing assembly 402 and the hinge assembly, between second housing assembly 404 and the hinge assembly, and/or between any other mechanical or electrical components of foldable computing device 400. Specifically, cloth 408 may vary in dimensions, thickness, and/or material so as to effectively create one or more seals between the hinge assembly and a portion of interior 416 of first housing assembly 402, and between the hinge assembly and a portion of interior 417 of second housing assembly 404, and/or between any other mechanical or electrical components of foldable computing device 400. In some examples, cloth 408 may create a thin seal or micro-seal. Cloth 408 may comprise a thickness between about 20 micrometers (+/−20%) and about 100 micrometers (+/−20%). In some examples, cloth 408 may create a moderately thick seal. Cloth 408 may comprise a thickness between about 100 micrometers (+/−20%) and about 1000 micrometers (+/−20%).

As shown in the example of FIG. 4, cloth 408 may span at least an edge of the hinge assembly including hinge cover 406 and hinge mechanism 412. Specifically, foldable computing device 400 may be assembled such that cloth 408 is disposed between at least a portion of interior 416 of first housing assembly 402 and at least a portion of the hinge assembly. Further, cloth 408 may be disposed between at least a portion of interior 417 of second housing assembly 404 and at least a portion of the hinge assembly. Thus, as shown in the example of FIG. 4, cloth 408 spans gap 415A between first housing assembly 402 and the hinge assembly, and spans gap 415B between second housing assembly 404 and the hinge assembly. That is, cloth 408 may be disposed in gaps 415 that are present between the hinge assembly (i.e., one or more of hinge cover 406 and hinge mechanism 412), first housing assembly 402, first housing assembly 404, and any other mechanical and electrical structures described herein. As such, cloth 408 may create a first seal between the portion of interior 416 of first housing assembly 402 and the hinge assembly, and create a second seal between the portion of interior 417 of second housing assembly 404 and the hinge assembly. In this way, cloth 408 may reduce intrusion of particulates from outside of foldable computing device 400 to the first subset of the plurality of electrical components included in first housing assembly 402 and the second subset of the plurality of electrical components included in second housing assembly 404.

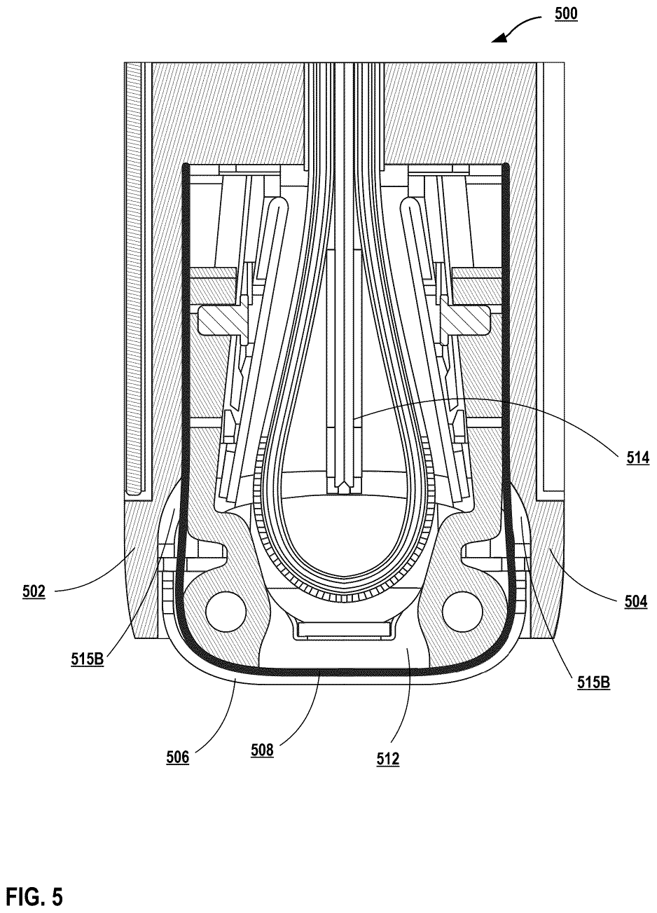

FIG. 5 is a diagram illustrating another view of the foldable device of FIG. 1 including a first housing assembly mechanically joined to a second housing assembly by a hinge assembly, in accordance with one or more aspects of this disclosure. Foldable computing device 500, first housing assembly 502, second housing assembly 504, cloth 508, hinge cover 506, and hinge mechanism 512 may each represent another view of foldable computing device 100, first housing assembly 102, second housing assembly 104, cloth 108, hinge cover 106, and hinge mechanism 112 of FIG. 1, respectively. The example of FIG. 5 includes gaps 515A and 515B, which may be similar to gaps 415A and 415B of FIG. 4, respectively. As shown in the example of FIG. 5, foldable computing device 500 includes a foldable display 514. Foldable display 514 may span the hinge assembly and at least a portion of first housing assembly 502 and at least a portion of second housing assembly 504. The example of FIG. 5 may be considered a view of foldable computing device 500 in a folded position.

In general, foldable computing device 500 may include foldable display 514, which may be a foldable (or flexible) display. Foldable display 514 may be one continuous display that can flex or bend without breaking when first housing assembly 502 moves relative to second housing assembly 504. Foldable display 514 may be disposed, in some instances, over the entirety (or nearly the entirety considering bezels and other holes for placement of ports or other openings to accommodate the electrical components, such as a camera, a speaker, a microphone, a fingerprint reader, etc.) of the interior portions of both first housing assembly 502 and second housing assembly 504. Foldable display 514 may be capable of rendering data into images viewable by a user of foldable computing device 500. For example, foldable display 514 may include a matrix of pixels that are individually controllable. Examples of foldable display 514 include, but are not limited to, liquid crystal displays (LCD), light emitting diode (LED) displays, organic light-emitting diode (OLED) displays, micro light-emitting diode (microLED) displays, an active matrix OLED (AMOLED, any other display capable of bending or otherwise flexing along an axis (e.g., a middle line of the display either length-or width-wise, such as axis 101 of FIG. 1), or any similar monochrome or color displays capable of outputting visible information to a user of foldable computing device 500.

In some examples, foldable computing device 500 may include other components, such as a foldable display module, which may include foldable display 514, along with one or more other components, such as one or more backplates that may provide structural support to foldable display 514. For instance, the foldable display module may comprise a backplate having a first region that that may provide structural support to portions of foldable display 514 proximate to first housing assembly 502, a second region that may provide structural support to portions of foldable display 514 proximate to second housing assembly 504, and a flexible region that may provide structural support to portions of foldable display 514 that bend (e.g., proximate to the hinge assembly). In some examples, a backplate may comprise one or more of stainless steel (SUS), aluminum, polyimide, polyethylene terephthalate, polycarbonate, glass, plastics such as acrylonitrile butadiene styrene, composite materials such as a combination of fiberglass and resins or carbon fiber composites, magnesium alloys, hybrid substrates including flexible polymers with thin layers of materials such as metal foils or glass, organic materials such as organic polymers and thin-film organic semiconductors, and the like. In some examples, brackets 103 of FIG. 1 may function similarly to a backplate. In some examples, foldable computing device 500 may include a foldable display edge overlaid on top of a portion of a foldable display module and the hinge assembly at an edge of foldable computing device 500. In some examples, the foldable display edge may be considered a decorative trim that surrounds one or more edges of a display, such as foldable display 514 of FIG. 5. The foldable display edge may act as a bumper or bezel that absorbs shocks or impacts and prevents direct contact with the display or any components of a foldable display module. The foldable display edge may be adhered (at least partially) on top of a foldable display module and/or the hinge assembly. In some examples, foldable computing device 500 may include DST that adheres or otherwise joins one or more foldable display edges to one or more portions of the hinge assembly.

In general, foldable computing device 500 comprises first housing assembly 502 that includes a first subset of a plurality of electrical components, and second housing assembly 504 that includes a second subset of the plurality of electrical components. Foldable computing device 500 comprises hinge cover 506 coupled to first housing assembly 502 and second housing assembly 504. Cloth 508 may be joined to first housing assembly 502 and second housing assembly 504 across the hinge cover 506, e.g., with at least one tape, such as DST. As shown in the example of FIG. 5, hinge mechanism 512 may be joined to first housing assembly 502, hinge cover 506, and second housing assembly 504, in which cloth 508 may be disposed between hinge mechanism 512 and first housing assembly 502, hinge cover 506, and second housing assembly 504. Specifically, cloth 508 may be disposed between at least a portion of an interior of first housing assembly 502 and at least a portion of the hinge assembly, and be disposed between at least a portion of an interior of second housing assembly 504 and at least a portion of the hinge assembly.

In general, hinge cover 506 and hinge mechanism 512 may form a hinge assembly, in which the hinge assembly is disposed between first housing assembly 502 and second housing assembly 504. The hinge assembly may facilitate opening and closing of first housing assembly 502 relative to second housing assembly 504. As such, when one of or both first housing assembly 102 and second housing assembly 104 rotates around the hinge assembly, cloth 508 may also move around or in accordance with the hinge assembly, without inhibiting the functionality of the hinge assembly and/or any other electrical and/or mechanical structures of computing device 500. That is, as shown in the example of FIG. 5, in general, cloth 508 may fold, stretch, flex, bend, or otherwise move without breaking or distorting the display (e.g., foldable display 514) of foldable computing device 500 when first housing assembly 502 moves relative to second housing assembly 504. That is, in the example of FIG. 5, foldable computing device 500 is shown in a closed position, or when first housing assembly 502 is closed relative to second housing assembly 504, which bends or folds cloth 508 along a middle axis and adjacent portions of the hinge assembly. As such, cloth 508 may fold, stretch, flex, bend, or otherwise move to accommodate the curvature created when first housing assembly 502 is partially closed or fully closed relative to second housing assembly 504. First housing assembly 502 and second housing assembly 504 may be joined to hinge cover 506, cloth 508, and hinge mechanism 512 by one or more screws.

In general, the hinge assembly including hinge cover 506 and hinge mechanism 512 may be arranged such that there is a first gap 515A between first housing assembly 502 and the hinge assembly (i.e., one or more of hinge cover 506 and hinge mechanism 512) and a second gap 515B between second housing assembly 504 and the hinge assembly. In some examples, one or more of gaps 515A, 515B, and/or other gaps not shown in the example of FIG. 5 may be in a range from about 0.05 mm to about 1 mm depending on the position of foldable computing device 500, e.g., a maximum gap may be present when foldable computing device 500 is in an open configuration and first housing assembly 502 is positioned at an angle of 40 degrees relative to second housing assembly 504. Gaps 515A and 515B may be considered major dust ingression paths between hinge cover 506 and first housing assembly 502 and second housing assembly 504. As shown in FIG. 5, cloth 508 may span gap 515A between first housing assembly 502 and the hinge assembly and gap 515B between second housing assembly 504 and the hinge assembly. Specifically, cloth 508 may create a first seal between the portion of the interior of first housing assembly 502 and the hinge assembly, and may create a second seal between the portion of the interior of second housing assembly 504 and the hinge assembly. As such, dust and other particulates from outside of foldable computing device 500 may not intrude to the first subset of the plurality of electrical components included in first housing assembly 502 and the second subset of the plurality of electrical components included in second housing assembly 504. In some examples, cloth 508 may be securely attached, e.g., via DST, to hinge mechanism 512 and/or hinge cover 506, such that there is no space or gap between cloth 508 and hinge mechanism 512 and/or hinge cover 506 where they are attached. In some examples, though, cloth 508 may not span or fill all gaps present along the edges of computing device 500, such that relevant gaps are maintained between the mechanical and/or electrical structures of computing device 500 in the x-, y-, and z-directions. In some examples, cloth 508 may not include an extra width or length to accommodate the curvature created when first housing assembly 502 is closed relative to second housing assembly 504. In some examples, cloth 508 spans a full length of the hinge assembly. In some examples, cloth 508 spans a full width of the hinge assembly.

In some examples, cloth 508 may provide a low level of resistance when first housing assembly 502 moves relative to second housing assembly 504, or when foldable computing device 500 is closed or folded. In some examples, cloth 508 may provide no resistance or an insignificant amount of resistance when first housing assembly 502 moves relative to second housing assembly 504, or when foldable computing device 500 is closed or folded.

In this way, cloth 508 may not inhibit the opening or closing of foldable computing device 500 (and from a user perspective, in terms of detecting different levels of resistance, provide a smooth and nonresistant transition from an open configuration to a closed configuration for foldable computing device 500) or the operation of the hinge assembly. In this respect, cloth 508 may not provide a uniform stiffness (or resistance) but instead may fold, stretch, flex, bend, or otherwise move when subjected to stress (e.g., when first housing assembly 502 is closed relative to second housing assembly 504). In some examples, cloth 508 may not deform when subjected to stress.

In this respect, various aspects of the techniques described in this disclosure may reduce contact or ingression of particulates (e.g., dust) with the electrical components of a foldable computing device, which may occur in gaps between mechanical structures and electrical components present at the edges of foldable displays. Particulate ingression in a foldable computing device can lead to various damages such as delamination, growing dark spots (GDS), horizontal (H)-line, and ultra-thin glass (UTG) crack, which can negatively affect the device's normal functionality. Thus, the techniques described may help to better maintain the functionality and longevity of a foldable computing device, without negatively impacting user experience when folding or unfolding the foldable computing device.

Various aspects have been described in this disclosure. These and other aspects are within the scope of the following claims.

This disclosure includes the following examples:
Example 1: A foldable computing device includes a first housing assembly that includes a first subset of a plurality of electrical components; a second housing assembly that includes a second subset of the plurality of electrical components; a hinge cover coupled to the first housing assembly and the second housing assembly, a cloth joined to the first housing assembly and the second housing assembly across the hinge cover; and a hinge mechanism joined to the first housing assembly, the hinge cover, and the second housing assembly, wherein the cloth is disposed between the hinge mechanism and the first housing assembly, the hinge cover, and the second housing assembly.
Example 2: The foldable computing device of example 1, wherein the hinge cover and hinge mechanism form a hinge assembly, wherein the hinge assembly is disposed between the first housing assembly and the second housing assembly, wherein the hinge assembly facilitates opening and closing of the first housing assembly relative to the second housing assembly, and wherein the hinge assembly is arranged such that there is a first gap between the first housing assembly and the hinge assembly and a second gap between the second housing assembly and the hinge assembly; and a foldable display that spans the hinge assembly and at least a portion of the first housing assembly and at least a portion of the second housing assembly.
Example 3: The foldable computing device of example 2, wherein the cloth spans the first gap between the first housing assembly and the hinge assembly and the second gap between the second housing assembly and the hinge assembly.
Example 4: The foldable computing device of any of examples 2 and 3, wherein the cloth spans a full length of the hinge assembly.
Example 5: The foldable computing device of any of examples 2 through 4, wherein the cloth spans a full width of the hinge assembly.
Example 6: The foldable computing device of any of examples 2 through 5, wherein the first housing assembly further comprises a first bracket, wherein the second housing assembly further comprises a second bracket, and wherein the first bracket and the second bracket further comprise a first plurality of fastener holes, wherein the hinge cover further comprises a second plurality of fastener holes, wherein the cloth further comprises a third plurality of fastener holes, and wherein the hinge mechanism further comprises a fourth plurality of fastener holes.
Example 7: The foldable computing device of example 6, wherein the first bracket and second bracket are joined to the hinge cover, the cloth, and the hinge mechanism by one or more screws.
Example 8: The foldable computing device of any of examples 6 and 7, wherein the cloth is disposed between at least a portion of an interior of the first housing assembly and at least a portion of the hinge assembly, and wherein the cloth is disposed between at least a portion of an interior of the second housing assembly and at least a portion of the hinge assembly.
Example 9: The foldable computing device of example 8, wherein the cloth creates a first seal between the portion of the interior of the first housing assembly and the hinge assembly, and wherein the cloth creates a second seal between the portion of the interior of the second housing assembly and the hinge assembly.
Example 10: The foldable computing device of any of examples 1 through 9, wherein the cloth reduces intrusion of particulates from outside of the foldable computing device to the first subset of the plurality of electrical components and the second subset of the plurality of electrical components.
Example 11: The foldable computing device of any of examples 1 through 10, wherein the cloth comprises a woven fabric including one of a thermoplastic polymer, a liquid crystal polymer, an amorphous polymer, and an elastomer.
Example 12: The foldable computing device of any of examples 1 through 11, wherein the cloth comprises a thickness within a range from about 20 micrometers to about 200 micrometers.
Example 13: The foldable computing device of any of examples 1 through 12, wherein the cloth is joined to the first housing assembly, the hinge cover, and the second housing assembly with a tape.
Example 14: The foldable computing device of any of examples 1 through 13, wherein the wherein the hinge cover includes at least two straight edges.
Example 15: The foldable computing device of example 14, wherein the cloth spans the at least two straight edges.

1. A foldable computing device comprising:
a first housing assembly that includes a first subset of a plurality of electrical components;
a second housing assembly that includes a second subset of the plurality of electrical components;
a hinge cover coupled to the first housing assembly and the second housing assembly,
a cloth joined to the first housing assembly and the second housing assembly across the hinge cover; and
a hinge mechanism joined to the first housing assembly, the hinge cover, and the second housing assembly, wherein the cloth is disposed between the hinge mechanism and the first housing assembly, the hinge cover, and the second housing assembly.

2. The foldable computing device of claim 1, wherein the hinge cover and hinge mechanism form a hinge assembly, wherein the hinge assembly is disposed between the first housing assembly and the second housing assembly, wherein the hinge assembly facilitates opening and closing of the first housing assembly relative to the second housing assembly, and wherein the hinge assembly is arranged such that there is a first gap between the first housing assembly and the hinge assembly and a second gap between the second housing assembly and the hinge assembly; and
a foldable display that spans the hinge assembly and at least a portion of the first housing assembly and at least a portion of the second housing assembly.

3. The foldable computing device of claim 2, wherein the cloth spans the first gap between the first housing assembly and the hinge assembly and the second gap between the second housing assembly and the hinge assembly.

4. The foldable computing device of claim 2, wherein the cloth spans a full length of the hinge assembly.

5. The foldable computing device of claim 2, wherein the cloth spans a full width of the hinge assembly.

6. The foldable computing device of claim 2, wherein the first housing assembly further comprises a first bracket, wherein the second housing assembly further comprises a second bracket, and wherein the first bracket and the second bracket further comprise a first plurality of fastener holes, wherein the hinge cover further comprises a second plurality of fastener holes, wherein the cloth further comprises a third plurality of fastener holes, and wherein the hinge mechanism further comprises a fourth plurality of fastener holes.

7. The foldable computing device of claim 6, wherein the first bracket and second bracket are joined to the hinge cover, the cloth, and the hinge mechanism by one or more screws.

8. The foldable computing device of claim 6, wherein the cloth is disposed between at least a portion of an interior of the first housing assembly and at least a portion of the hinge assembly, and wherein the cloth is disposed between at least a portion of an interior of the second housing assembly and at least a portion of the hinge assembly.

9. The foldable computing device of claim 8, wherein the cloth creates a first seal between the portion of the interior of the first housing assembly and the hinge assembly, and wherein the cloth creates a second seal between the portion of the interior of the second housing assembly and the hinge assembly.

10. The foldable computing device of claim 1, wherein the cloth reduces intrusion of particulates from outside of the foldable computing device to the first subset of the plurality of electrical components and the second subset of the plurality of electrical components.

11. The foldable computing device of claim 1, wherein the cloth comprises a woven fabric including one of a thermoplastic polymer, a liquid crystal polymer, an amorphous polymer, and an elastomer.

12. The foldable computing device of claim 1, wherein the cloth comprises a thickness within a range from about 20 micrometers to about 200 micrometers.

13. The foldable computing device of claim 1, wherein the cloth is joined to the first housing assembly, the hinge cover, and the second housing assembly with a tape.

14. The foldable computing device of claim 1, wherein the hinge cover includes at least two straight edges.

15. The foldable computing device of claim 14, wherein the cloth spans the at least two straight edges.
